(19) United States
(12) Patent Application Publication
(10) Pub. No.: US 2023/0407798 A1
(43) Pub. Date: Dec. 21, 2023

(54) GAS TURBINE ENGINE SYSTEM

(71) Applicant: ROLLS-ROYCE plc, London (GB)

(72) Inventors: Marko BACIC, Oxford (GB); Jonathan E. HOLT, Derby (GB)

(73) Assignee: ROLLS-ROYCE plc, London (GB)

(21) Appl. No.: 18/174,806

(22) Filed: Feb. 27, 2023

(30) Foreign Application Priority Data
Mar. 23, 2022 (GB) 2204040.6

(51) Int. Cl. F02C 9/46; F02C 9/40; F02C 3/22

(52) U.S. Cl. CPC F02C 9/46; F02C 9/40; F02C 3/22

(57) ABSTRACT

A gas turbine engine system includes a hydrogen-burning gas turbine engine and a fuel system including a fuel line arranged to receive gaseous hydrogen at an input thereof and provide the gaseous hydrogen to combustion apparatus of the hydrogen-burning gas turbine engine and a vent line including a vent valve and having a first end coupled to the fuel line and a second end disposed remotely from the hydrogen-burning gas turbine engine. A controller is arranged to switch the vent valve from a closed state to an open state upon detection of an engine shaft-break or similar condition, thus providing rapid evacuation of gaseous hydrogen from the fuel line and hence rapid shut-down of the engine. The engine may be shut down more rapidly than is possible by means of a shut-off valve within the fuel line.

### TECHNICAL FIELD

The invention relates to gas turbine engine systems.

### BACKGROUND

Hydrogen-burning gas turbine engine systems are of interest for both stationary power and propulsion applications as they do not produce carbon dioxide at the point of use. In such an engine system, hydrogen is provided to combustion apparatus of an engine in gaseous form, although it may be stored in liquid form. In aircraft propulsion applications, it is important to provide for rapid shut-off of fuel to an engine in the event of a fan-blade off, shaft breakage or a similar occurrence. In a conventional gas turbine engine, a shut-off valve in the engine's fuel line may be used to isolate combustion apparatus of the engine from its fuel supply and provide rapid engine shut-down. However, unlike kerosene, gaseous hydrogen is compressible. Therefore, if a hydrogen-burning gas turbine engine is fed with hydrogen by means of a fuel line including a shut-off valve, hydrogen may continue to flow into combustion apparatus of the engine briefly following closure of the shut-off valve, driven by the pressure differential between hydrogen in the fuel line and the combustion apparatus. Fuel provided to the combustion apparatus after activation of the shut-off valve may delay shutdown of the engine sufficiently that, in the event of a shaft-break, the angular speed of a turbine of the engine may reach a critical level, leading to a disc burst or multiple blade release which in turn results in hazardous uncontained release of engine debris.

### BRIEF SUMMARY

According to a first aspect of the present invention, a gas turbine engine system comprises a hydrogen-burning gas turbine engine and a fuel system which comprises (i) a fuel line arranged to receive gaseous hydrogen at an input thereof and provide the gaseous hydrogen to combustion apparatus of the hydrogen-burning gas turbine engine and (ii) a vent line including a vent valve and having a first end coupled to the fuel line and a second end disposed remotely from the hydrogen-burning gas turbine engine. The vent line allows the hydrogen-burning gas turbine engine to be shut down more rapidly than is the case using a shut-off valve within the fuel line.

The second end of the vent line may be coupled to the exhaust or bypass duct of the hydrogen-burning gas turbine engine. When the vent valve in the fuel line is opened, gaseous hydrogen within the fuel line is rapidly evacuated therefrom. Alternatively, the gas turbine engine system may further comprise a dump tank, the second end of the vent line being coupled to the dump tank. The dump tank may have a volume of five times, or more, the volume of the fuel line. The dump tank may have a volume of ten times, or more, the volume of the fuel line. Gaseous hydrogen vented from the fuel line may thereby be captured rather than lost from the gas turbine engine system.

The gas turbine engine system may comprise a store of compressed gaseous hydrogen coupled to the input of the fuel line. A shut-off valve may be provided at the input of the fuel line, providing for the store of gaseous hydrogen to be isolated from the fuel line when the vent valve is opened, thus preventing further gaseous hydrogen entering the fuel line.

Alternatively, the gas turbine engine system may further comprise a store of liquid hydrogen and an evaporator arranged to receive and evaporate liquid hydrogen from the store and provide resulting gaseous hydrogen to the input of the fuel line.

The gas turbine engine system may comprise a controller arranged to open the vent valve in response to detection of a shaft-break of the hydrogen-burning gas turbine engine or other event. The controller may be a Full-Authority Digital Electronic Controller of the hydrogen-burning gas turbine engine. In the case where a store of compressed gaseous hydrogen is coupled to the fuel line via a shut-off valve, the controller may be arranged to close the shut-off off valve and open the vent valve in the vent line simultaneously or substantially simultaneously.

A second aspect of the invention provides an aircraft comprising a gas turbine engine according to the first aspect.

### BRIEF DESCRIPTION OF THE DRAWINGS

Embodiments of the invention are described below by way of example only and with reference to the accompanying drawings in which:

FIG. 1 shows a first example gas turbine engine system of the invention; and

FIG. 2 shows a second example gas turbine engine system of the invention.

### DETAILED DESCRIPTION

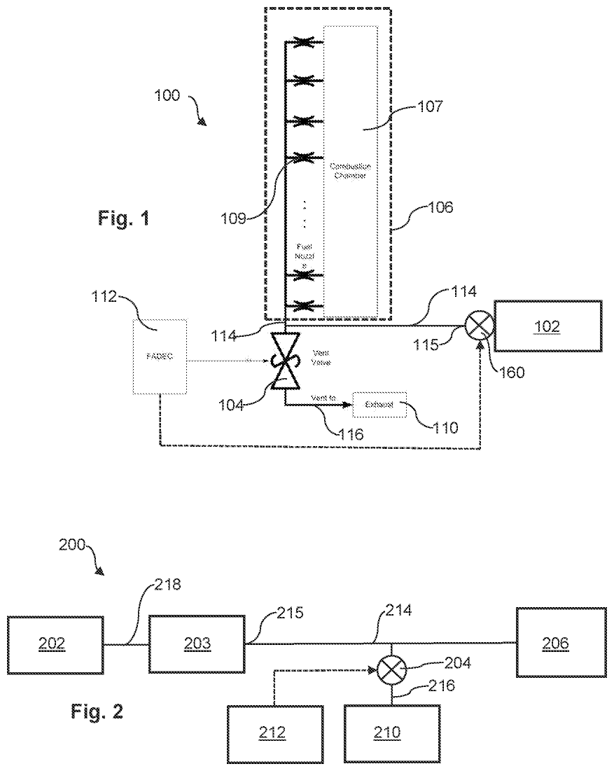

Referring to FIG. 1, a gas turbine engine system 100 comprises a hydrogen-burning gas turbine engine which includes combustion apparatus 106. The combustion apparatus comprises a combustion chamber 107 fed by a plurality of fuel nozzles such as 109. The gas turbine engine system 100 further comprises a fuel store 102 of gaseous hydrogen and a fuel line 114 having an input 115, the fuel line 114 coupling the fuel store 102 to the combustion apparatus 106. The fuel store 102 is coupled to the input 115 of the fuel line 114 via a shut-off valve 160. A vent line 116 including a vent valve 104 couples the fuel line 114 to the exhaust flow 110 of the hydrogen-burning gas turbine engine. The state of the vent valve 104 (either open or closed) is controlled by a controller 112 which may be the FADEC (Full-Authority Digital Electronic Controller) of the hydrogen-burning gas turbine engine.

In normal operation of the gas turbine engine system 100, the vent valve 104 is closed, shut-off valve 160 is open and gaseous hydrogen introduced at the input 115 of the fuel line 114 is conveyed to the combustion apparatus 106. Upon detection of an engine shaft-break or similar condition requiring rapid engine shut-down, the controller 112 causes the vent valve 104 to switch from its closed state to its open state such that hydrogen within the fuel line 114 and combustion apparatus 106 is rapidly vented to the exhaust 110 of the hydrogen-burning gas turbine engine, thus producing rapid shut-down of the hydrogen-burning gas turbine engine. With the vent valve 104 in its open state, the combustion apparatus 106 and the input 115 of the fuel line 114 are both coupled to the exhaust 110, which provides a region much lower pressure than that found in the fuel line 114 during normal operation of the system 100 and hence rapid evacuation of gaseous hydrogen gas from the fuel line 114.

The shut-off valve 160 is also controlled by the FADEC 112 and closed when the vent valve 104 is switched from its closed state to its open state in order to prevent further gaseous hydrogen entering the fuel line 114.

In a variant of the system 100, the vent line 116 couples the fuel line 114 to the bypass duct of the hydrogen-burning gas turbine engine, or alternatively to a dump tank having a volume of five times or ten times, or more, the volume of the fuel line 114.

Hydrogen evacuated from the fuel line 114 may thereby be recovered and used subsequently. More generally, the end of the vent line 116 is at some location remote from the hydrogen-burning gas turbine engine, allowing hydrogen within the fuel line 114 to be evacuated and safely vented away from possible ignition sources.

FIG. 2 shows a second example gas turbine engine system 200 of the invention. The system 200 comprises a hydrogen-burning gas turbine engine having combustion apparatus 206 and a fuel line 214 having an input 215 arranged to receive gaseous hydrogen in normal operation of the system 200. A vent line 216 includes a vent valve 204 and couples the fuel line 214 to a dump tank 210, the dump tank 210 having a volume which is five or ten times, or more, the volume of the fuel line 214. The state of the vent valve 204 (i.e. open or closed) is controlled by a controller 212, which may be the FADEC of the hydrogen-burning gas turbine engine.

In normal operation of the gas turbine engine system, the vent valve 204 is closed and gaseous hydrogen introduced into the input 215 of the fuel line 214 is conveyed to the combustion apparatus 206. Upon detection of an engine shaft-break or similar condition requiring rapid engine shut-down, the controller 212 switches the vent valve 204 to its open state such that fuel line 214 is coupled to the dump tank 210, thus rapidly evacuating gaseous hydrogen from the fuel line 214. The hydrogen removed to the dump tank 210 may be used subsequently by the system 100.

With the vent valve 204 in its open state, the hydrogen-burning gas turbine engine is rapidly shut down due to rapid evacuation of gaseous hydrogen from the fuel line 214 caused by the much lower pressure within the dump tank 210 compared to that in the fuel line 214.

In ordinary operation of the system 200, the vent valve 204 is in its closed state and gaseous hydrogen is provided to the input 215 of the first fuel line 214 from an evaporator 203 arranged to receive liquid hydrogen from a liquid hydrogen store 202 via a cryogenic line 218.

The input 215 of the first fuel line 214 may be provided with a shut-off valve (not shown) also under control of the controller 212 and arranged to close when the vent valve 204 is switched from its closed state to its open state, thus preventing further gaseous hydrogen entering the fuel line 214.

In a variant of the system 200, dump tank 210 is omitted and vent line 216 couples the fuel line 214 to the exhaust or bypass duct of the hydrogen-burning gas turbine engine of the system 200, or alternatively to some location remote from the hydrogen-burning gas turbine engine.

1. A gas turbine engine system comprising a hydrogen-burning gas turbine engine and a fuel system which comprises:
a fuel line arranged to receive gaseous hydrogen at an input thereof and provide the gaseous hydrogen to combustion apparatus of the hydrogen-burning gas turbine engine; and
a vent line including a vent valve and having a first end coupled to the fuel line and a second end disposed remotely from the hydrogen-burning gas turbine engine.

2. A gas turbine engine system according to claim 1 wherein the second end of the vent line is coupled to the exhaust of the hydrogen-burning gas turbine engine.

3. A gas turbine engine system according to claim 1 wherein the second end of the vent line is coupled to the bypass duct of the hydrogen-burning gas turbine engine.

4. A gas turbine engine system according to claim 1 further comprising a dump tank having a volume of at least five times the volume of the fuel line and wherein the second end of the vent line is coupled to the dump tank.

5. A gas turbine engine system according to claim 4 wherein the dump tank has a volume of at least ten times the volume of the fuel line.

6. A gas turbine engine system according to claim 1 and wherein the fuel system further comprises a store of compressed gaseous hydrogen coupled to the input of the fuel line.

7. A gas turbine engine system according to claim 6 further comprising a shut-off valve at the input of the fuel line.

8. A gas turbine engine system according to claim 1 wherein the fuel system further comprises a store of liquid hydrogen and an evaporator arranged to receive and evaporate liquid hydrogen from the store and provide resulting gaseous hydrogen to the input of the fuel line.

9. A gas turbine engine system according to claim 1 further comprising a controller arranged to open the vent valve in response to detection of a shaft-break of the hydrogen-burning gas turbine engine.

10. A gas turbine engine system according to claim 9 wherein the controller is a Full-Authority Digital Electronic Controller of the hydrogen-burning gas turbine engine.

11. A gas turbine engine system according to claim 7 wherein the controller is further arranged to close the shut-off valve in response to detection of a shaft-break of the hydrogen-burning gas turbine engine.

12. An aircraft comprising a gas turbine engine system according to claim 1.

13. A gas turbine engine system according to claim 9 wherein the controller is further arranged to close the shut-off valve in response to detection of a shaft-break of the hydrogen-burning gas turbine engine.
